(19) United States
(12) Patent Application Publication
(10) Pub. No.: US 2007/0207848 A1
(43) Pub. Date: Sep. 6, 2007

(54) Random draw keno game

(76) Inventor: John Edward Roethel, Las Vegas, NV (US)

Correspondence Address: JOHN EDWARD ROETHEL, 2290 S. JONES BLVD. #100, LAS VEGAS, NV, 89146, US

(21) Appl. No.: 11/712,666

(22) Filed: Feb. 28, 2007

Related U.S. Application Data
(60) Provisional application No. 60/779,367, filed on Mar. 2, 2006.

(51) Int. Cl. G06F 19/00

(52) U.S. Cl. 463/18

(57) ABSTRACT

A keno game method includes initially randomly selecting a predetermined number of keno numbers to be drawn from the total keno number pool after the player has selected one or more keno numbered spots that the player hopes to match. The amount of keno numbers selected to be drawn from the total keno number pool varies from round to round and is determined randomly. A player will not know how many numbers are being drawn when the player makes his wager and selects the keno numbers he wishes to play.

### CROSS-REFERENCE TO RELATED APPLICATION

This application is based on and claims the benefit of U.S. Provisional Application Ser. No. 60/779367, filed Mar. 2, 2006, entitled “Random Draw Keno Game”.

This invention relates primarily to a live or electronic video keno game, and more particularly to a live or electronic video keno game in which the amount of the keno numbers drawn from the keno number pool is varied from round to round, with the amount of the keno numbers drawn being determined on a random basis at the start of each round of the game.

### BACKGROUND OF THE INVENTION

Keno is a well known game and has been played in gaming establishments for many years. In conventional keno, there are eighty numbers in the pool of numbers that may be drawn in any one round of the game. In the typical keno game, eighty keno balls are numbered 1 through 80 and are placed in an air blower device that circulates the keno balls. Twenty of the eighty keno balls are selected each game.

Each player marks a keno ticket that is a 10×8 matrix having ten columns and eight rows. The keno numbers from one through eighty are printed on the keno ticket with each keno number having its own numbered spot. Prior to the start of a round of the keno game, a player selects between one and fifteen numbered spots that the player thinks will be drawn during the game. Typically a player uses a crayon-like pencil to mark the numbered spots he wishes to play on his keno ticket and the player takes his marked keno ticket to a keno station. The player makes an appropriate wager and turns in his marked keno ticket and the money at the keno station. The player receives back a stamped and receipted ticket showing the amount of the player's wager and the numbered spots that the player has selected.

The keno game operator then proceeds to draw twenty keno numbers from the eighty keno balls. Depending on the number of matches or “Hits” between the twenty keno numbers drawn and the numbered spots selected by the player, the player wins or loses. The more keno numbers that match the player's numbered spots, the higher the payoff to the player.

In a live keno game, multiple players participate in each game and no players may win, some players may win or all players may win on each round of play of the keno game. In traditional live keno, players may select between one and fifteen numbered spots and wagers can range from as little as 35¢ a game to $5, $10 or even higher dollars per game. Typically each establishment operating a keno game will provide a group of keno pay tables showing the amount that it is possible for the player to win based on the amount wagered, the amount of numbered spots selected by the player and the number of matches or “Hits” achieved by the player when the twenty keno balls are selected.

For example, if the player wagers $1 and selects one numbered spot, the player will typically win $3 if his selected numbered spot is one of the twenty numbered keno balls drawn during the play of the game. Similarly, if the player selects fifteen numbered spots, the player will typically be paid if anywhere between a total of eight and fifteen of his numbered spots match the twenty numbered keno balls drawn. The highest payout will be made for matching fifteen out of fifteen, with lower payouts made for matching fourteen out of fifteen, thirteen out of fifteen and so on down to eight out of fifteen. Any matches of seven or less numbered spots are typically losing plays. Similar payout schemes are provided when the player marks between one and fifteen numbered spots during any round of a keno game.

When the player plays an electronic video keno gaming machine, a single player plays against the keno gaming machine for each round of the game and the player either wins or loses each round. The player wagers a coin, token or credit and selects the quantity of numbered spots that the player is attempting to match or “Hit” during that round of the game. All eighty numbers are displayed on a video screen with a 10×8 matrix similar to that of a keno ticket. The numbered spots are selected by the player using a light pen, or by pressing the numbered spots on a selection panel or by touching the numbered spots selected using conventional touch screen technology.

In the typical electronic keno format, the player may select between one and ten numbered spots to attempt to match. After the player has completed selecting the numbered spots that the player wishes to match and has made the appropriate wager, the player presses the “Start” button. This causes the electronic controls of the gaming machine to randomly select twenty keno numbers from the pool of eighty keno numbers and the selected keno numbers are displayed to the player. The electronic controls of the gaming machine determine whether the player has achieved a winning payout at the conclusion of each round of the game. Just as in live keno, the player wins when he matches or “Hits” all or a predetermined minimum number of his selected numbered spots. If the player matches less than the predetermined minimum number of his selected numbered spots, then the player loses his wager. Payouts are made by accruing credits on the credit meter of the gaming machine or dispensing coins or tokens into a payout tray.

The basic principles of the play of keno are set out in Scarne's New Complete Guide to Gambling, by John Scarne, at pages 490-499.

The drawback of traditional keno is that the amount of selected keno numbers is always a fixed amount, usually twenty numbers.

It is an object of the present invention to provide an improved keno game in which the amount of keno numbers that are drawn on any particular round of play is randomly determined prior the drawing of keno numbers starting.

### SUMMARY OF THE INVENTION

A keno game method includes initially randomly selecting a predetermined number of keno numbers to be drawn from the total keno number pool after the player has selected one or more keno numbered spots that the player hopes to match. The amount of keno numbers selected to be drawn from the total keno number pool varies from round to round and is determined randomly. A player will not know how many numbers are being drawn when the player makes his wager and selects the keno numbers he wishes to play.

### DETAILED DESCRIPTION OF THE PREFERRED EMBODIMENTS

The method of the present invention is played using either a live keno game format or using an electronic keno gaming machine. The description that follows refers to an electronic keno gaming machine, but the same principles of the present invention can be easily adapted to a live keno game format.

A typical keno game uses a total keno number pool of eighty keno numbers, usually numbered one through eighty, and twenty keno numbers are drawn from that eighty keno number pool. The player receives a payout or not based on how many of the player's selected numbers match the keno numbers drawn from the total keno number pool.

For example, if the player plays an Eight Spot (the player selects eight numbers out of the total pool size of eighty numbers), the player wins a payout if the player matches (or “Hits”) at least four of the drawn keno numbers.

A representative Eight Spot pay table is shown in Table 1 and the player would win five credits for each unit wagered by the player for achieving five out of eight “Hits” in the base game.

TABLE 1

| Hits | Game Pay |
|---|---|
| 0 | 0 |
| 1 | 0 |
| 2 | 0 |
| 3 | 0 |
| 4 | 1 |
| 5 | 5 |
| 6 | 70 |
| 7 | 750 |
| 8 | 10000 |

Any suitable pay table can be used depending on the payout percentage which the gaming establishment wishes to offer to the player. Using a probability analysis, calculations can be done to determine the probability of any amount of numbered spots being “Hit” according to the size of the total keno number pool and quantity of keno numbers selected or drawn from the total keno number pool.

The method of the present invention includes initially randomly selecting a predetermined amount of keno numbers to be drawn from the total keno number pool. This selection occurs after the player has selected one or more keno numbered spots that the player hopes to match. The amount of keno numbers to be drawn from the total keno number pool varies from round to round and is determined randomly. A player will not know how many keno numbers are to be drawn when the player makes his wager and selects the keno numbers he wishes to play.

The method of playing of the keno game of the present invention would entail initially providing a total keno number pool, typically eighty keno numbers. The player can then make a wager, if the game is being played as a casino wagering game, and the player would select one or more keno numbers to be matched. After the player has made his selection of keno numbers to be matched, randomly determining the amount of actual keno numbers to be drawn for that round of play.

The play of the game then proceeds by randomly selecting from the total keno number pool the actual keno numbers drawn for that round of play. The number of matches achieved by the player is determined by comparing the keno numbers selected by the player with the actual keno numbers drawn.

If the player has achieved the required number of matches, the player is provided with an award based on the number of matches achieved by the player. If the game is being played as a casino wagering game, the amount of the award is also based on the amount of the player's wager.

In a preferred embodiment of the present invention, the average amount of keno numbers to be drawn from the total keno number pool would be predetermined and maintained at twenty keno numbers to conform to the typical pay tables currently in use. However, on a random basis, the amount of keno numbers actually drawn in any particular game would vary. For example, in one game perhaps only eighteen keno numbers are drawn, but in a subsequent game perhaps twenty-two keno numbers are drawn. In still other games, twenty keno numbers are drawn as would be the average amount of keno numbers to be drawn.

In those games in which less than twenty keno numbers are drawn, the player would be at a disadvantage versus the theoretical game return since the pay table being used in based on a twenty keno number draw. But in those games in which more than twenty keno numbers are drawn, the player would be at an advantage versus the theoretical game return since the pay table being used in based on a twenty keno number draw.

From the perspective of the gaming establishment, the overall theoretical game return would not change since the average amount of keno numbers being drawn stays at twenty and corresponds to the game return for the pay table being offered.

In an alternative embodiment of the present invention, the pay table offered to the player would change based on the amount of keno numbers being drawn. After the player makes his wager and selects his keno numbers which he hopes will be matched, a random amount of keno numbers is determined to be drawn for that round of play. The randomly determined amount of keno numbers to be drawn for that round of play is displayed or announced to the player and a suitable pay table is displayed for that amount of keno numbers to be drawn.

If a consistent overall game return is desired, then the pay table varies based on the amount of keno numbers to be drawn. For example, if the player is playing an Eight Spot, it would be more difficult to match Five out of Eight numbers if only eighteen keno numbers are being drawn and thus higher payouts can be provided relative to a pay table based on twenty keno numbers being drawn.

Similarly, if the player is playing an Eight Spot, it would be less difficult to match Five out of Eight numbers if twenty-two keno numbers are being drawn and thus lower payouts can be provided relative to a pay table based on twenty keno numbers being drawn if it is desired to maintain a consistent overall game return.

In a preferred embodiment of the present invention, the total keno number pool would be eighty numbers. The average amount of keno numbers to be drawn would be twenty numbers. The range of actual keno numbers drawn would vary between eighteen and twenty-two, with the amount of keno numbers to be drawn on any particular round of play to be randomly selected.

In other embodiments of the present invention, the total keno number pool could be more or less than eighty numbers. The average amount of keno numbers to be drawn could be more or less than twenty numbers. The range of actual keno numbers drawn could be any suitable range above and below the average amount of keno numbers to be drawn.

While the present invention has been described in the context of a keno game, the present invention could also be adapted to lottery games which are basically the same as keno since a pool of numbers are used and the player attempts to match his selected numbers with the numbers drawn during the play of the lottery.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. A method of playing a keno game comprising:
a) providing a total keno number pool;
b) allowing the player to select one or more keno numbers to be matched;
c) after the player has made his selection of keno numbers to be matched, randomly determining the amount of actual keno numbers to be drawn;
d) randomly selecting from the total keno number pool the actual keno numbers drawn;
e) determining the number of matches achieved by the player by comparing the keno numbers selected by the player with the actual keno numbers drawn; and
f) providing the player with an award based on the number of matches achieved by the player.

2. The method of claim 1 in which the player makes a wager to participate in the keno game and the award to the player is based on the amount of the wager.

3. The method of claim 1 in which an average amount of actual keno numbers to be drawn is predetermined.

4. The method of claim 3 in which the amount of actual keno numbers to be drawn could be more, less or the same as the average amount.

5. The method of claim 4 in which the total keno number pool is eighty numbers, the average amount of actual keno numbers to be drawn is twenty and the amount of actual keno numbers drawn is in the range of eighteen to twenty-two.
